(19) United States
(12) Patent Application Publication
(10) Pub. No.: US 2015/0149516 A1
(43) Pub. Date: May 28, 2015

(54) INFORMATION PROCESSING APPARATUS, INFORMATION PROCESSING METHOD, AND STORAGE MEDIUM

(71) Applicant: Ayumi IWASAKI, Tokyo (JP)

(72) Inventor: Ayumi IWASAKI, Tokyo (JP)

(73) Assignee: RICOH COMPANY, LTD., Tokyo (JP)

(21) Appl. No.: 14/547,368

(22) Filed: Nov. 19, 2014

(30) Foreign Application Priority Data
Nov. 25, 2013 (JP) 2013-242840
Nov. 5, 2014 (JP) 2014-224967

(51) Int. Cl. G06F 17/30

(52) U.S. Cl. CPC G06F 17/30179
USPC 707/827

(57) ABSTRACT

An information processing apparatus is connected via a network to an electronic apparatus, and includes a first storage that stores a first file received from the electronic apparatus in response to a request from the electronic apparatus, a detection unit that detects that the first file is stored in the first storage, a similarity calculation unit that calculates similarity levels between the first file and other files stored in the first storage based on characteristic information of the first file and characteristic information of the other files when the detection unit detects that the first file is stored in the first storage, and a first conversion unit that generates a second file by converting a first data format of the first file into a second data format different from the first data format based on the similarity levels.

### CROSS-REFERENCE TO RELATED APPLICATIONS

The present application is based upon and claims the benefit of priority of Japanese Patent Application No. 2013-242840 filed on Nov. 25, 2013 and Japanese Patent Application No. 2014-224967 filed on Nov. 5, 2014, the entire contents of which are incorporated herein by reference.

### BACKGROUND OF THE INVENTION

1. Field of the Invention

An aspect of this disclosure relates to an information processing apparatus, an information processing method, and a storage medium.

2. Description of the Related Art

Devices such as personal computers (PC) and smart devices request files with various data formats depending on purposes. Japanese Laid-Open Patent Publication No. 2013-054623, for example, discloses a technology to quickly respond to requests for files with various data formats. In the disclosed technology, each file is converted into files with various data formats in advance, and the files with various data formats are stored as “cache” files.

With the technology of Japanese Laid-Open Patent Publication No. 2013-054623, however, a large amount of storage space is necessary to store the cache files with various data formats, and a shortage of the storage space may occur. It may be possible to reduce the amount of storage space by storing only cache files for a limited number of data formats. However, this approach reduces the probability (cache hit ratio) that a file with a data format requested by a device can be returned to the device.

### SUMMARY OF THE INVENTION

In an aspect of this disclosure, there is provided an information processing apparatus connected via a network to an electronic apparatus. The information processing apparatus includes a first storage that stores a first file received from the electronic apparatus in response to a request from the electronic apparatus, a detection unit that detects that the first file is stored in the first storage, a similarity calculation unit that calculates similarity levels between the first file and other files stored in the first storage based on characteristic information of the first file and characteristic information of the other files when the detection unit detects that the first file is stored in the first storage, and a first conversion unit that generates a second file by converting a first data format of the first file into a second data format different from the first data format based on the similarity levels.

### BRIEF DESCRIPTION OF THE DRAWINGS

FIG. 1 is a drawing illustrating an exemplary configuration of an information storage system;

FIG. 2 is a block diagram illustrating an exemplary hardware configuration of an information storage apparatus;

FIG. 3 is a block diagram illustrating an exemplary functional configuration of an information storage apparatus;

FIG. 4 is a drawing used to describe an exemplary process performed by an information storage system;

FIG. 5 is a flowchart illustrating an exemplary process performed by an information storage apparatus;

FIG. 6 is a table illustrating exemplary retention periods of cache files;

FIG. 7 is a sequence chart illustrating an exemplary process performed in an information storage system;

FIG. 8 is a flowchart illustrating an exemplary data format determination process;

FIG. 9 is a drawing illustrating an exemplary file display screen;

FIG. 10 is a flowchart illustrating another exemplary process performed by an information storage apparatus; and

FIGS. 11A and 11B are drawings used to describe an exemplary process of revising the composition of cache files.

### DESCRIPTION OF THE PREFERRED EMBODIMENTS

Embodiments of the present invention are described below with reference to the accompanying drawings.

### First Embodiment

### <System Configuration>

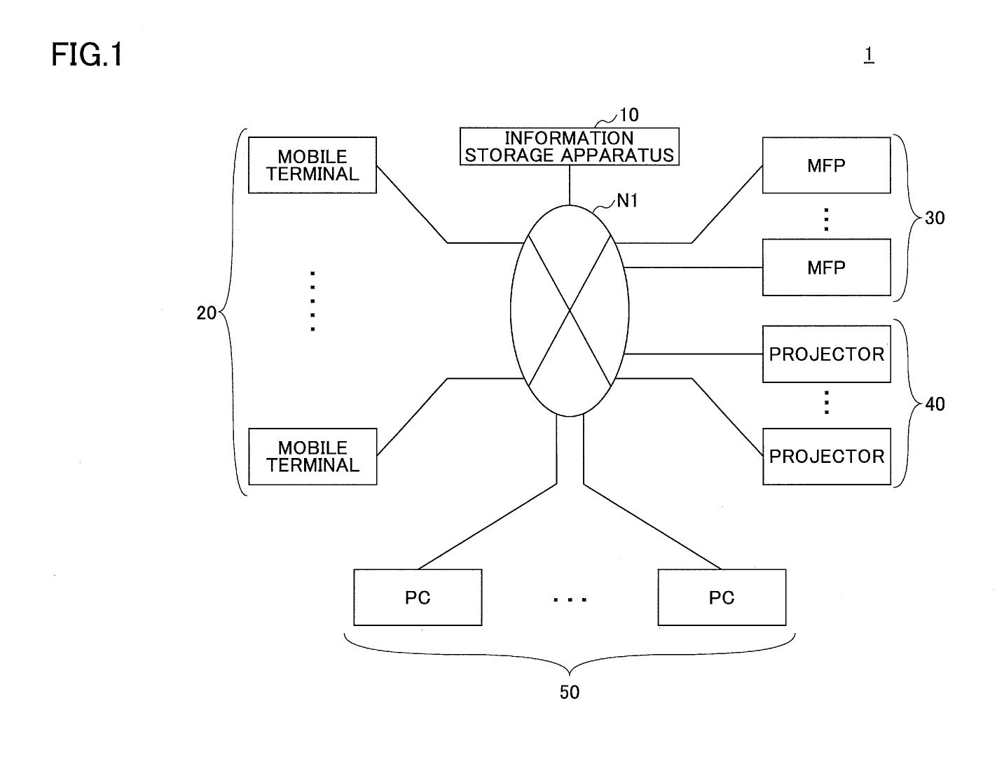

FIG. 1 is a drawing illustrating an exemplary configuration of an information storage system 1 according to an embodiment. As illustrated by FIG. 1, the information storage system 1 may include an information storage apparatus 10, one or more mobile terminals 20, one or more multifunction peripherals (MFP) 30, one or more projectors 40, and one or more personal computers (PC) 50 that are connected to a network N1 such as a local area network (LAN). For descriptive purposes, each of the mobile terminals 20, the MFPs 30, the projectors 40, and the PCs 50 may be referred in a singular form.

The network N1 is, for example, a private network such as an intranet.

The information storage apparatus 10 is an example of an information processing apparatus. The information storage apparatus 10 is a computer system storing files that can be accessed from the mobile terminal 20, the MFP 30, the projector 40, and the PC 50. The mobile terminal 20, the MFP 30, the projector 40, and the PC 50 can obtain files from and store files in the information storage apparatus 10. The information storage apparatus 10 converts the data format of a stored file into specified data formats to generate “cache files” with the specified data formats, and stores the generated cache files. Thus, in the present application “cache files” indicate files generated from a file stored in the information storage apparatus 10 and having data formats different from the original data format of the file.

The mobile terminal 20 is an example of an electronic apparatus that is carried and operated by a user. The mobile terminal 20 may be any apparatus that a user can carry and operate. Examples of the mobile terminal 20 include a smartphone, a tablet terminal, and a cell phone. The mobile terminal 20 can access the information storage apparatus 10 and obtain a file stored in the information storage apparatus 10. Also, the mobile terminal 20 can send a file stored in a storage area of the mobile terminal 20 to the information storage apparatus 10, and store the file in the information storage apparatus 10.

The MFP 30 is an example of an electronic apparatus. The MFP 30 includes an imaging function, an image forming function, and a communication function, and can be used as a printer, a facsimile machine, a scanner, and a copier. The MFP 30 can print a file obtained from the information storage apparatus 10 via, for example, the mobile terminal 20. Also, the MFP 30 can scan a document to generate a file, and store the generated file in the information storage apparatus 10 via, for example, the mobile terminal 20.

The projector 40 is an example of an electronic apparatus. The projector 40 includes a projecting function and a communication function. The projector 40 can project a file obtained from the information storage apparatus 10 via, for example, the mobile terminal 20.

The PC 50 is an example of an electronic apparatus. Examples of the PC 50 include a desktop PC and a notebook PC that a user can operate. The PC 50 can access the information storage apparatus 10 and obtain a file stored in the information storage apparatus 10. Also, the PC 50 can send a file stored in a storage area of the PC 50 to the information storage apparatus 10, and store the file in the information storage apparatus 10.

The above described configuration of the information storage system 1 is just an example. The information storage system 1 may include, instead of or in addition to the above described electronic apparatuses, one or more of an interactive whiteboard (i.e., an electronic whiteboard), a terminal for a video conference, a camera, a microphone, a speaker, and a display.

### <Hardware Configuration>

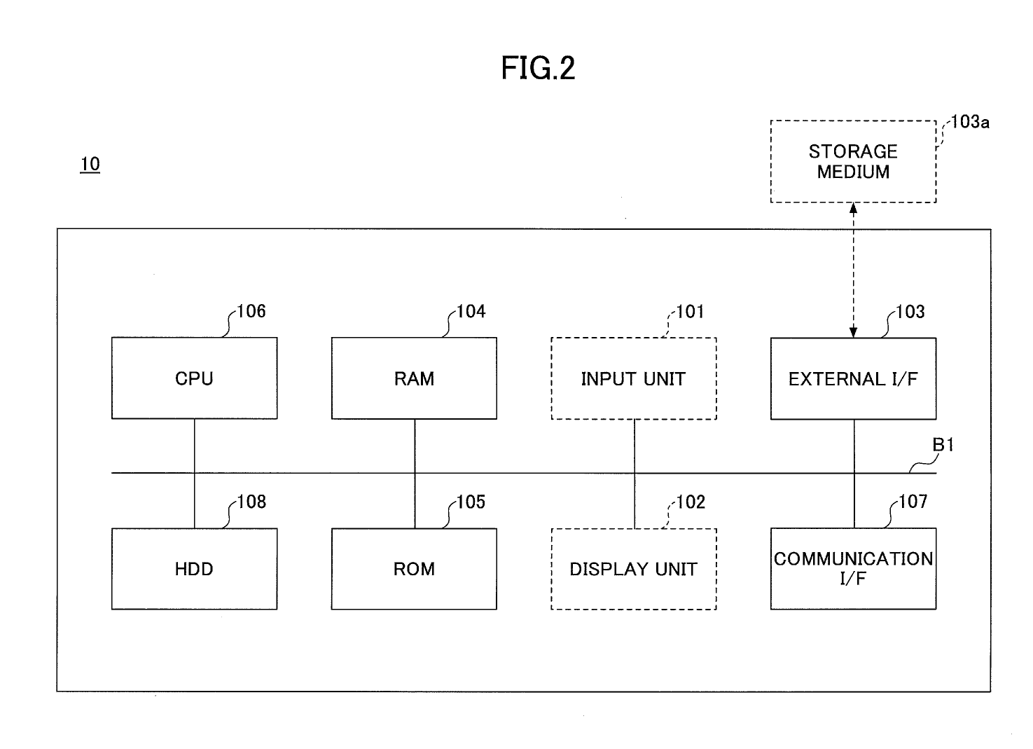

The information storage apparatus 10 may have a hardware configuration as illustrated by FIG. 2. FIG. 2 is a block diagram illustrating an exemplary hardware configuration of the information storage apparatus 10.

As illustrated by FIG. 2, the information storage apparatus 10 may include an input unit 101, a display unit 102, an external I/F 103, a random access memory (RAM) 104, a read-only memory (ROM) 105, a central processing unit (CPU) 106, a communication I/F 107, and a hard disk drive (HDD) 108 that are connected to each other via a bus B1.

The input unit 101 includes, for example, a keyboard and a mouse, and is used to input instructions (or operation signals) to the information storage apparatus 10. The display unit 102 displays, for example, processing results of the information storage apparatus 10. The input unit 101 and the display unit 102 are not essential components of the information storage apparatus 10, and may be omitted.

The communication I/F 107 is an interface for connecting the information storage apparatus 10 to the network N1. The information storage apparatus 10 can perform data communications with other apparatuses via the communication I/F 107.

The HDD 108 is a non-volatile storage device for storing various programs and data. For example, the HDD 108 stores basic software or an operating system (OS) for controlling the entire information storage apparatus 10, and application software for providing various functions on the OS. The HDD 108 may manage the stored programs and data using a file system and/or a database (DB).

The external I/F 103 is an interface between the information storage apparatus 10 and an external storage such as a storage medium 103a. The information storage apparatus 10 can read and write data from and to the storage medium 103a via the external I/F 103. The storage medium 103a may be implemented by, for example, a flexible disk, a compact disk (CD), a digital versatile disk (DVD), a secure digital (SD) memory card, or a universal serial bus (USB) memory.

The ROM 105 is a non-volatile semiconductor memory (storage device) that can retain programs and data even when power is turned off. For example, the ROM 105 stores programs and data such as a basic input/output system (BIOS) that is executed when the information storage apparatus 10 is turned on, and system and network settings of the information storage apparatus 10. The RAM 104 is a volatile semiconductor memory (storage device) for temporarily storing programs and data.

The CPU (processor) 106 loads programs and data from storage devices (e.g., the ROM 105 and the HDD 108) into the RAM 104 and executes the loaded programs to control the information storage apparatus 10 and to implement various functional units of the information storage apparatus 10.

With the above hardware configuration, the information storage apparatus 10 can provide various functions as described below.

### <Software Configuration>

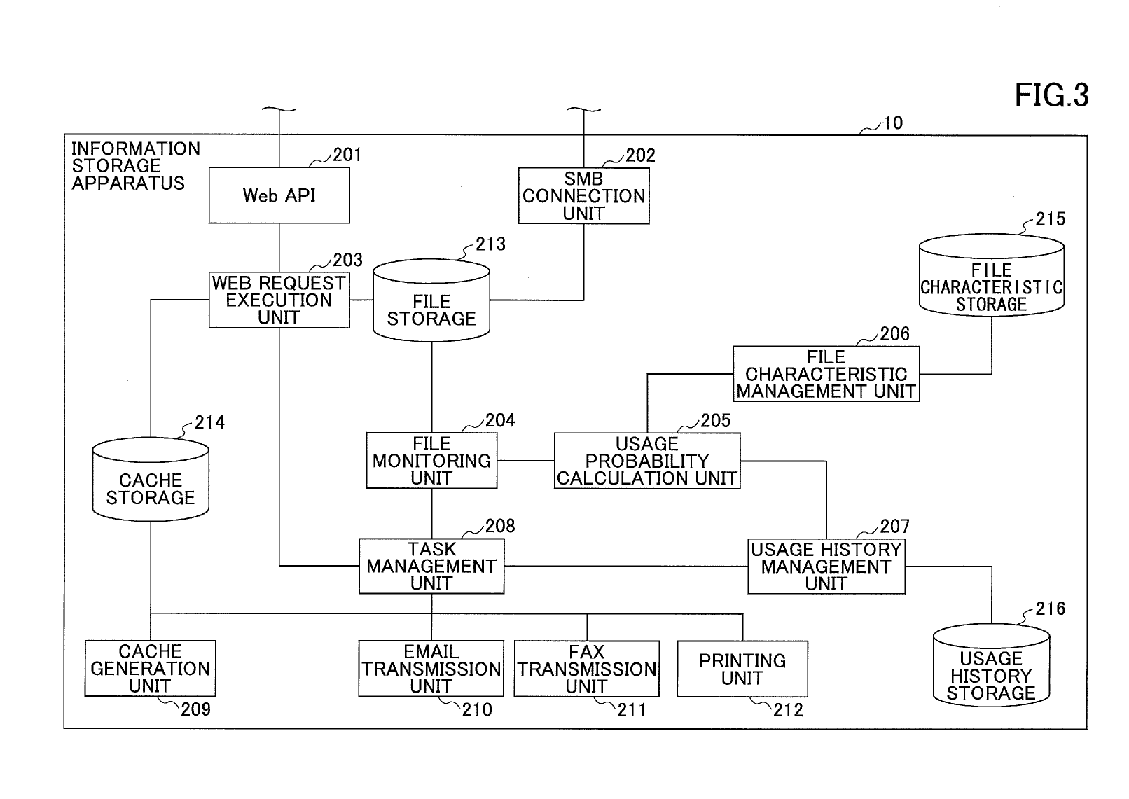

The information storage apparatus 10 of the present embodiment may include functional units (or processing blocks) as illustrated by FIG. 3. FIG. 3 is a block diagram illustrating an exemplary functional configuration of the information storage apparatus 10.

The information storage apparatus 10 may include a Web API (application programming interface) 201, an SMB (server message block) connection unit 202, a Web request execution unit 203, a file monitoring unit 204, a usage probability calculation unit 205, a file characteristic management unit 206, a usage history management unit 207, a task management unit 208, a cache generation unit 209, an email transmission unit 210, a fax transmission unit 211, and a printing unit 212. These functional units may be implemented by executing one or more programs installed in the information storage apparatus 10 by the CPU 106.

Also, the information storage apparatus 10 uses a file storage 213, a cache storage 214, a file characteristic storage 215, and a usage history storage 216. These storages may be implemented, for example, by the HDD 108 and/or a storage device connected via a network to the information storage apparatus 10. Also, some or all of the storages may be implemented by a storage device of the information storage apparatus 10 other than the HDD 108. For example, the file storage 213, the file characteristic storage 215, and the usage history storage 216 may be implemented by the HDD 108, and the cache storage 214 may be implemented by another storage device of the information storage apparatus 10.

The Web API 201 is available via the network N1. The Web API 201 is an interface that enables, for example, the mobile terminal 20 to obtain a list of folders and files in the information storage apparatus 10. The Web API 201 also enables, for example, the mobile terminal 20 to obtain files from and store files in the information storage apparatus 10. The Web API 201 may be implemented by, for example, a function or a class.

The Web API 201 of the information storage apparatus 10 may be provided as a software development kit (SDK) to developers of applications installed in, for example, the mobile terminal 20. Application developers can develop applications using the SDK. The SDK may also be provided to third vendors other than the vendor of the information storage apparatus 10. The third vendors can develop applications using the SDK. Applications developed using the SDK can be installed in the mobile terminal 20.

Thus, providing the Web API 201 of the information storage apparatus 10 as an SDK to third vendors makes it possible for the mobile terminal 20 to use not only applications developed by the vendor of the information storage apparatus 10 but also applications developed by the third vendors.

The SMB connection unit 202 is available via the network N1. The SMB connection unit 202 is an interface that enables, for example, the PC 50 to obtain files from and store files in the information storage apparatus 10.

The Web request execution unit 203 receives an HTTP request from the Web API 201, performs a process corresponding to the received HTTP request, and returns an HTTP response. When an acquisition request (e.g., an HTTP request) for requesting a file is received via the Web API 201 from the mobile terminal 20, the Web request execution unit 203 may determine whether the mobile terminal 20 can display the requested file (i.e., whether the mobile terminal 20 supports the data format of the requested file). Also, when an acquisition request for requesting a file is received via the Web API 201 from the mobile terminal 20, the Web request execution unit 203 obtains a file (or a cache file) that the mobile terminal 20 can display from the file storage 213 (or the cache storage 214).

The file monitoring unit 204 monitors the file storage 213, and detects that a file has been newly stored in the file storage 213. The usage probability calculation unit 205 calculates cache usage probabilities based on which cache files to be stored in the cache storage 214 are generated. Also, the usage probability calculation unit 205 calculates similarity levels based on file characteristic information obtained by the file characteristic management unit 206.

The file characteristic management unit 206 obtains file characteristic information used to calculate cache usage probabilities. The usage history management unit 207 updates usage history information of a file when the file is obtained from the file storage 213 by, for example, the mobile terminal 20.

The task management unit 208 manages an output request received via the Web API 201 and the Web request execution unit 203 from the mobile terminal 20. The output request is for requesting the information storage apparatus 10 to output a file to an electronic apparatus such as the MFP 30 or the projector 40 that is different from the mobile terminal 20 sending the output request. Also, the task management unit 208 manages a cache generation request received via the file monitoring unit 204 from the usage probability calculation unit 205.

The cache generation unit 209 generates cache files from a file stored in the file storage 213 based on cache usage probabilities calculated by the usage probability calculation unit 205. The cache files are generated by converting the data format of the file stored in the file storage 213 into different data formats.

The email transmission unit 210 sends, for example, a file stored in the information storage apparatus 10 as an email message to a specified destination. The fax transmission unit 211 sends, for example, information in a file stored in the information storage apparatus 10 as a facsimile message to a specified destination. The printing unit 212 requests a printing apparatus such as the MFP 30 to print, for example, information in a file stored in the information storage apparatus 10 with specified print settings.

The file storage 213 stores files. The mobile terminal 20 and the PC 50 can obtain and display files stored in the file storage 213. Also, the mobile terminal 20 and the PC 50 can store files in the file storage 213. The file storage 213 is made public as a shared folder on the network N1 via, for example, the Server Message Block (SMB) protocol. The cache storage 214 stores cache files generated by the cache generation unit 209. The file characteristic storage 215 stores file characteristic information regarding characteristics of files stored in the file storage 213. For example, the file characteristic information may include file characteristic items such as a file name, an extension, an input method (which indicates, for example, whether the file is stored by the mobile terminal 20, stored by the PC 50, or scanned and stored by the MFP 30), and a document type (e.g., graphic data, document data, or photographic data). The usage history storage 216 stores usage history information of files stored in the file storage 213. The usage history information indicates a usage count for each data format (e.g., PDF) of each file stored in the file storage 213, i.e., the number of times the file with the data format has been obtained (or used) by the mobile terminals 20 and the PCs 50.

### <Processes>

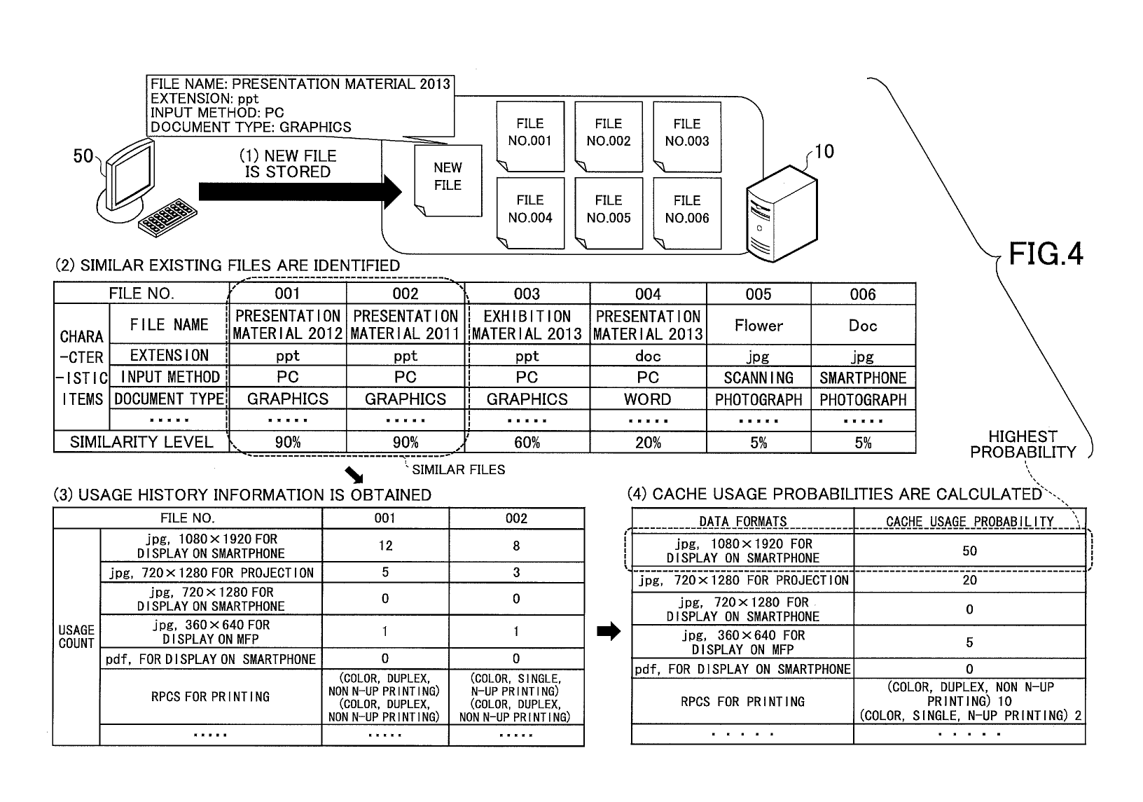

An exemplary process performed by the information storage system 1 of the present embodiment is described below. FIG. 4 is a drawing used to describe an exemplary process performed by the information storage system 1.

In this exemplary process, it is assumed that the file storage 213 of the information storage apparatus 10 stores files No. 001 through No. 006, and the PC 50 stores another file (which is hereafter referred to as a “new file”) in the file storage 213.

The PC 50 stores the new file in the file storage 213 of the information storage apparatus 10 (FIG. 4 (1)). Then, file characteristic information (e.g., file names, extensions, input methods, and document types) of the files No. 001 through No. 006 are obtained from the file characteristic storage 215, and similarity levels indicating the degrees of similarity between the files No. 001 through No. 006 and the new file are calculated based on the file characteristic information of the files No. 001 through No. 006 and file characteristic information of the new file (FIG. 4 (2)). Next, usage history information of some of the files No. 001 through No. 006 having high similarity levels (in this example, the file No. 001 and the file No. 002) is obtained (FIG. 4 (3)). Next, cache usage probabilities are calculated based on the obtained usage history information, and cache files are generated based on the cache usage probabilities (FIG. 4 (4)). The cache usage probabilities indicate the probabilities that respective data formats of a file will be used. In the example of FIG. 4 (4), cache usage probabilities are provided for respective data formats, and a data format “jpg, 1080×1920 for display on smartphone” has the highest cache usage probability and is most likely to be used. Therefore, in this exemplary process, a cache file with the data format “jpg, 1080×1920 for display on smartphone” is generated for the new file.

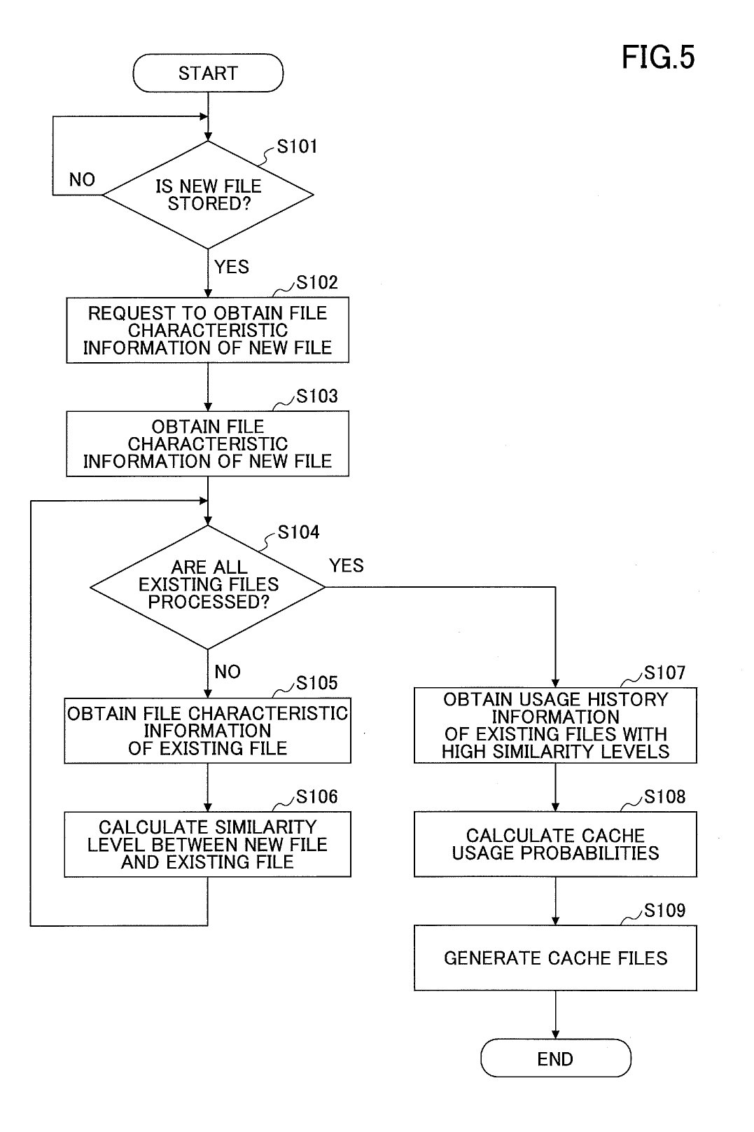

Next, an exemplary process performed by the information storage apparatus 10 of the present embodiment is described. FIG. 5 is a flowchart illustrating an exemplary process performed by the information storage apparatus 10.

At step S101, the file monitoring unit 204 monitors the file storage 213. When detecting that a new file has been stored in the file storage 213 by, for example, the mobile terminal 20 or the PC 50, the file monitoring unit 204 proceeds to step S102. For example, the file monitoring unit 204 determines at predetermined intervals whether a new file has been stored in the file storage 213. The file monitoring unit 204 repeats step S101 until the storage of a new file in the file storage 213 is detected.

At step S102, the usage probability calculation unit 205 requests the file characteristic management unit 206 to obtain file characteristic information of the new file stored in the file storage 213.

At step S103, the file characteristic management unit 206 obtains the file characteristic information of the new file stored in the file storage 213. For example, the file characteristic management unit 206 obtains a file name, an extension, an input method, and a document type of the new file as the file characteristic information.

Then, the file characteristic management unit 206 and the usage probability calculation unit 205 repeat steps S105 and S106, respectively, until it is determined at step S104 that steps S105 and S106 are performed for all existing files. Here, the existing files indicate files that have already been stored in the file storage 213 before the new file is stored in the file storage 213 by the mobile terminal 20 or the PC 50 at step S101.

At step S105, the file characteristic management unit 206 obtains file characteristic information of an existing file from the file characteristic storage 215. The file characteristic management unit 206 obtains file characteristic information of the existing file including file characteristic items that are the same as those obtained at step S103 for the new file. For example, the file characteristic management unit 206 obtains a file name, an extension, an input method, and a document type of the existing file as the file characteristic information.

At step S106, the usage probability calculation unit 205 calculates a similarity level between the new file and the existing file based on the file characteristic information of the new file obtained at step S103 and the file characteristic information of the existing file obtained at step S105. The similarity level indicates the degree of similarity between, for example, the usages and/or properties of the new file and the existing file. When the similarity level between the new file and the existing file is high, the probability that the new file and the existing file are used for a similar purpose is high. For example, when a file A is for display on a smart phone and the similarity level between the file A and another file B is high, it is highly likely that the file B is also used for display on a smartphone.

The similarity level may be calculated, for example, by determining matching levels for respective file characteristic items in the file characteristic information and weighting the determined matching levels. For example, the similarity level may be calculated by determining matching levels of the following file characteristic items and weighting the determined matching levels: file names (the number of matching characters), extensions (same or different), input methods (same or different), document types (same or different), and locations where files are stored (e.g., whether folder names are the same, the number of matching characters of folder names, whether file paths are the same, or the number of matching characters of file paths).

In the example of FIG. 4 (2), the similarity level is expressed by percentage. However, the similarity level may also be expressed by any other appropriate value that can quantitatively indicate the degree of similarity between the new file and the existing file. For example, the similarity level may be represented by the sum of matching levels, or by a remainder obtained by subtracting points of non-matching file characteristic items from a predetermined score.

Steps S105 and S106 described above are performed for all of the existing files. After the similarity levels between the new file and all the existing files are calculated, the process proceeds to step S107.

At step S107, the usage history management unit 207 obtains, from the usage history storage 216, usage history information of existing files whose similarity levels are high. For example, the usage history management unit 207 may select a predetermined number of existing files from the top in terms of the similarity levels, and obtain usage history information of the selected existing files. In the example of FIG. 4 (3), the top two existing files in terms of the similarity levels are selected.

At step S108, the usage probability calculation unit 205 calculates cache usage probabilities for respective data formats based on the usage history information obtained at step S107. For example, the cache usage probability of each data format may be calculated by averaging values in the usage history information for the data format. Also, the cache usage probability of each data format may be calculated by obtaining an average of values in the usage history information for the data format, and weighting the obtained average.

In FIG. 4, the cache usage probabilities of FIG. 4 (4) are calculated based on the usage history information of FIG. 4 (3). In the example of FIG. 4, the usage count of the file No. 001 and the usage count of the file No. 002 are added for each data format to obtain a sub-total usage count, and the cache usage probability of the data format is represented by a percentage of the sub-total usage count in a total usage count that is the sum of usage counts of all data formats. It is assumed that the new file will also be frequently used in a data format with a high cache usage probability.

At step S109, the cache generation unit 209 generates one or more cache files of the new file based of the cache usage probabilities calculated at step S108, and stores the generated cache files in the cache storage 214. The cache files are generated by converting the (original) data format of the new file into different data formats.

The cache generation unit 209 may generate cache files for a predetermined number (e.g., one or two) of data formats from the top in terms of the cache usage probabilities calculated at step S108. Because generating a large number of cache files may cause a shortage of storage space of the information storage apparatus 10, it is preferable to generate cache files for up to the top three data formats in terms of the cache usage probabilities. Also, the cache generation unit 209 may be configured to generate cache files for data formats that satisfy a predetermined criterion (e.g., data formats with cache usage probabilities greater than or equal to 50). Here, because of the reasons explained below, it is preferable to not delete the new file stored in the file storage 213 even after the cache files are generated.

In the example of FIG. 4, the extension of the new file stored in the file storage 213 is “ppt”. Because the top three data formats in terms of the cache usage probabilities in FIG. 4 are “jpg, 1080×1920 for display on smartphone”, “jpg, 720×1280 for projection”, and “RPCS for printing (color, duplex, non N-up printing)”, the original data format “ppt” of the new file is unlikely to be used. However, while “jpg” and “RPCS”, which are image data formats, are suitable for display, they are not suitable for editing. On the other hand, a file with the data format “ppt” can be easily edited. Accordingly, deleting the new file with the data format “ppt” may reduce the user convenience. For the above reasons, it is preferable to not delete the new file stored in the file storage 213.

Also, the order of generating cache files may be determined based on the cache usage probabilities. For example, cache files with different data formats may be generated one by one in descending order of the cache usage probabilities. This method makes it possible to quickly generate a cache file for a data format that is highly likely to be used.

The number of cache files to be generated for each file is preferably changeable via, for example, a PC of an administrator of the information storage system 1.

Cache files generated by the cache generation unit 209 may be stored in the file storage 213 instead of the cache storage 214. However, because the file storage 213 is a shared folder made public on the network N1, cache files are preferably stored in the cache storage 214 to improve the user convenience. This enables the user to obtain, store, and display a file using any device (e.g., the mobile terminal 20) without considering the data format of the file.

As described above, the present embodiment makes it possible to determine data formats that are highly likely to be used for a file stored in the information storage apparatus 10 based on file characteristic information, and generate cache files with the determined data formats for the file. Compared with a case where cache files are generated for all possible data formats, the present embodiment makes it possible to reduce the amount of storage space necessary to store cache files. Also in the present embodiment, existing files with high similarity to a newly stored file are determined, and cache files of the newly-stored file are generated based on usage history information of the existing files. This approach makes it possible to achieve a high cache hit ratio.

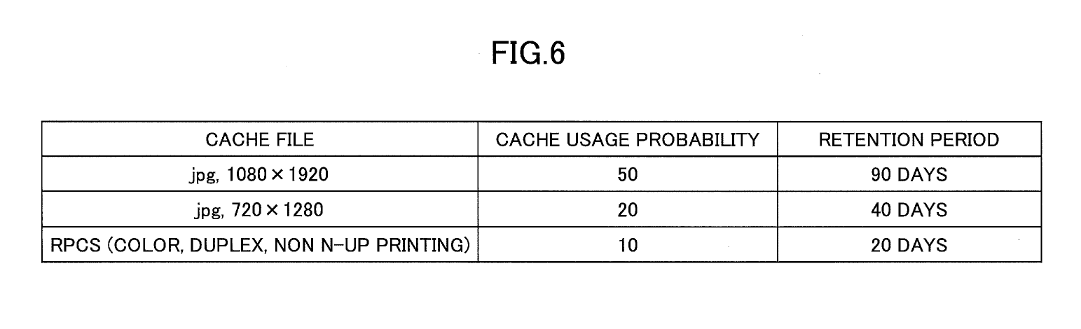

The cache generation unit 209 is preferably configured to delete cache files generated at step S109 after predetermined retention periods. FIG. 6 is a table illustrating exemplary retention periods of cache files. In the example of FIG. 6, retention periods of 90 days, days, and 20 days are set for the respective cache files. The retention periods indicate periods of time for which the cache files are retained in the information storage apparatus 10 or after which the cache files are deleted. It is preferable to set a longer retention period for a cache file with a higher cache usage probability and set a shorter retention period for a cache file with a lower cache usage probability.

Also, cache files may be deleted in the order they are generated (i.e., from the oldest to the newest) when the number of generated cache files exceeds a predetermined value.

Deleting generated cache files at predetermined timing makes it possible to prevent shortage of storage space of the information storage apparatus 10.

The retention periods of cache files are preferably changeable via, for example, a PC of an administrator of the information storage system 1.

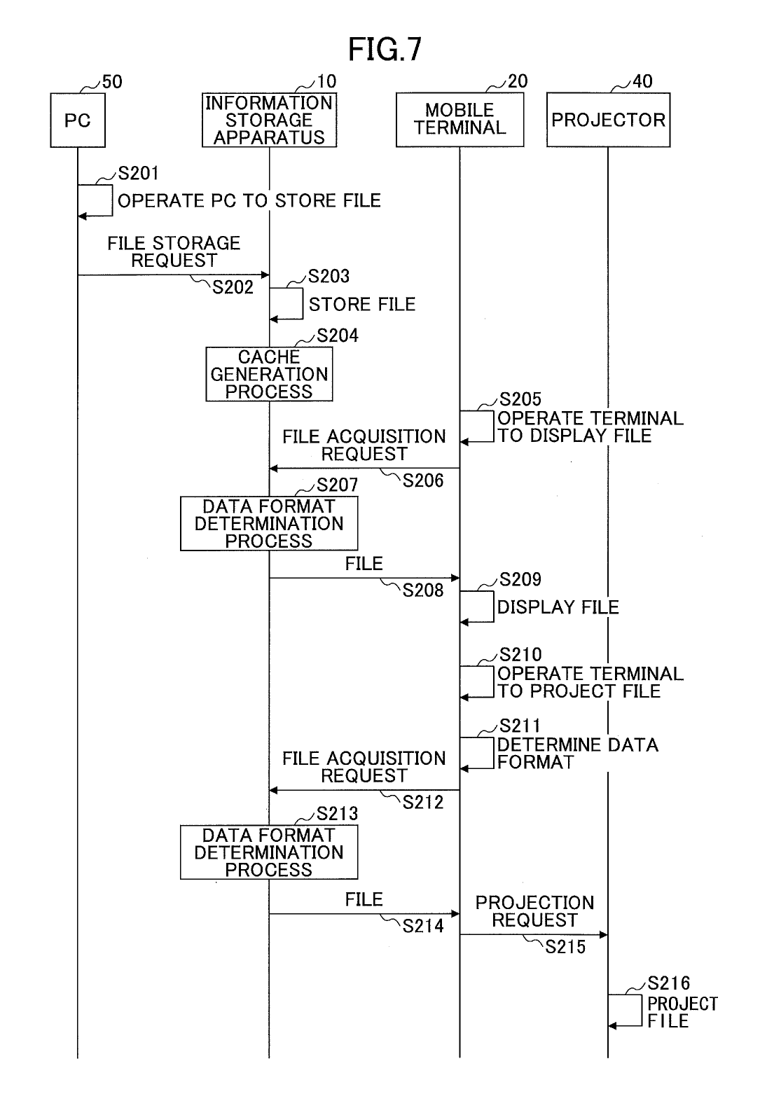

Next, another exemplary process performed in the information storage system 1 is described with reference to FIG. 7. In this exemplary process, after a file is stored in the information storage apparatus 10 by the PC 50, a user displays the file on the mobile terminal 20 and requests the projector 40 to project the file. FIG. 7 is a sequence chart illustrating an exemplary process performed in the information storage system 1.

At step S201, the user operates the PC 50 to store a file in the information storage apparatus 10.

At step S202, in response to the operation performed by the user, the PC 50 sends a file storage request including the file to the information storage apparatus 10.

At step S203, when receiving the file storage request including the file from the PC 50, the information storage apparatus 10 stores the file in the file storage 213.

At step S204, the information storage apparatus 10 performs a process as described with reference to FIG. 5 to generate cache files of the file stored in the file storage 213.

Subsequent steps S205 through S209 are related to a process where a user displays the stored file on a display screen of the mobile terminal 20.

At step S205, the user operates the mobile terminal 20 in order to display the file stored in the file storage 213 of the information storage apparatus 10.

At step S206, in response to the operation performed by the user, the mobile terminal 20 sends a file acquisition request for requesting the file to the information storage apparatus 10. The file acquisition request includes information (e.g., a file path) for identifying the requested file and a requested data format of the requested file.

The requested data format may be represented by, for example, an extension of a file or a resolution that the mobile terminal 20 can display. Also, in a case where the MFP 30 requests and obtains a file and prints the obtained file, file conversion parameters (e.g., N-up processing and duplex printing) may be specified as the requested data format. The requested data format may be determined based on the operation performed by the user at step S205. For example, when the operation is to display a file, a data format (e.g., jpg) that the mobile terminal 20 can display may be selected.

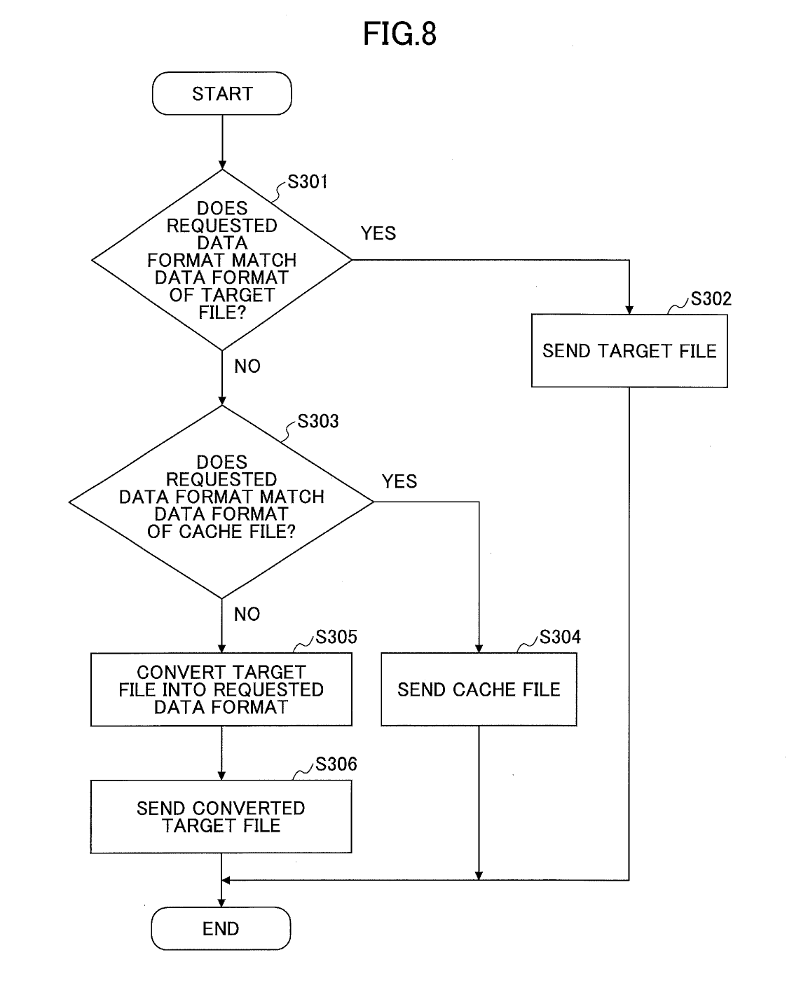

At step S207, when receiving the file acquisition request from the mobile terminal 20, the information storage apparatus 10 performs a data format determination process. Here, the information storage apparatus 10 receives the file acquisition request via the Web API 201. The data format determination process is described below with reference to FIG. 8. FIG. 8 is a flowchart illustrating an exemplary data format determination process.

The Web request execution unit 203 of the information storage apparatus 10 determines whether the requested data format matches the original data format of the requested file (target file) stored in the file storage 213 (step S301). When the requested data format matches the original data format of the requested file (YES at step S301), the Web request execution unit 203 sends the requested file via the Web API 201 to the mobile terminal 20 (step S302).

On the other hand, when the requested data format does not match the original data format of the requested file (NO at step S301), the Web request execution unit 203 determines whether the requested data format matches the data format of the cache file generated at step S204 of FIG. 7 (step S303). When multiple cache files exist for the requested file, the Web request execution unit 203 compares the requested data format with the data format of each of the cache files.

When the requested data format matches the data format of any cache file (YES at step S303), the Web request execution unit 203 sends the cache file via the Web API 201 to the mobile terminal 20 (step S304).

On the other hand, when the requested data format does not match any one of the data formats of the cache files (NO at step S303), the Web request execution unit 203 converts the requested file into the requested data format (step S305). Then, the Web request execution unit 203 sends the converted file via the Web API 201 to the mobile terminal 20 (step S306).

In step S305, when the information storage apparatus 10 is not capable of converting the file into the requested data format, the Web request execution unit 203 may be configured to send an error message to the mobile terminal 20 that has sent the file acquisition request.

Referring back to FIG. 7, at step S208, the information storage apparatus 10 sends the requested file to the mobile terminal 20 as described with reference to FIG. 8.

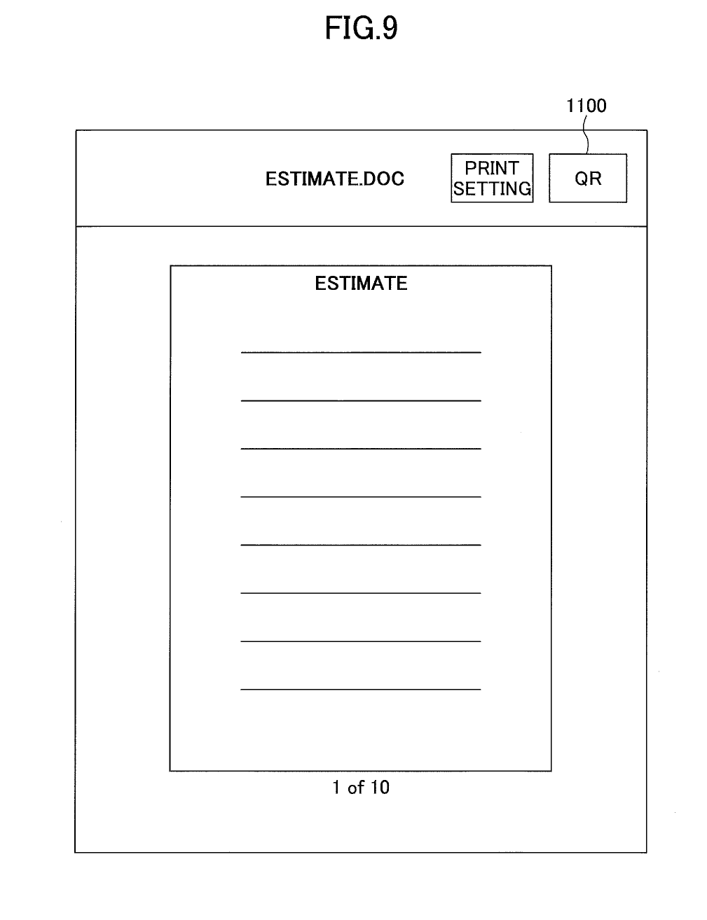

At step S209, the mobile terminal 20 receives the requested file from the information storage apparatus 10, and displays the received file on the display screen. As a result, the contents of the received file are displayed on the display screen of the mobile terminal 20 as exemplified by FIG. 9.

Subsequent steps S210 through S216 are related to a process where the user operates the mobile terminal 20 to request the projector 40 to project the file stored at step S204.

At step S210, the user operates the mobile terminal 20 in order to request the projector 40 to project the file stored in the file storage 213 of the information storage apparatus 10. This operation may be performed, for example, by pressing a QR button 1100 on the display screen of FIG. 9 displayed by the mobile terminal 20 to activate a camera of the mobile terminal 20 and by reading, with the camera, a QR code attached to the projector 40 to be used. From the read QR code, the mobile terminal 20 obtains address information (e.g., an IP address) on the network N1, identification information (e.g., a model number), and capability information (e.g., supported resolution and data format) of the projector 40. In this exemplary process, it is assumed that the user requests the projector 40 to project the file that is currently displayed on the mobile terminal 20.

Also in this exemplary process, the user selects a projector 40 by reading a QR code attached to the projector 40. However, a projector 40 used to project a file may be selected by any other appropriate method. For example, the mobile terminal 20 may be configured to display a list of projectors 40 on a screen to allow the user to select one of the projectors 40 from the list. Further, the user may select a projector 40 by directly entering the address information and the identification information of the projector 40 on a screen.

At step S211, the mobile terminal 20 determines a data format of the file to be obtained from the information storage apparatus 10 based on the capability information. For example, the mobile terminal 20 determines an extension “jpg” and a resolution “1200×1900 or lower” as the data format of the file to be obtained from the information storage apparatus 10 based on the capability information. Alternatively, the data format may be determined by the information storage apparatus 10. In this case, the mobile terminal 20 may be configured to send a file acquisition request including the capability information to the information storage apparatus 10 at step S212, and the information storage apparatus 10 may be configured to determine a file format of the requested file based on the capability information included in the file acquisition request.

At step S212, the mobile terminal 211 sends a file acquisition request including the data format determined at step S211 to the information storage apparatus 10.

At step S213, when receiving the file acquisition request from the mobile terminal 20, the information storage apparatus 10 performs a data format determination process in a manner similar to step S207 described above.

At step S214, the information storage apparatus 10 sends the file to the mobile terminal 20 in a manner similar to step S208 described above.

At step S215, when receiving the file from the information storage apparatus 10, the mobile terminal 215 sends a projection request including the received file to the projector 40. The projection request is sent to an address indicated by the address information obtained at step S210. The projection request may also include projection settings for projecting the file.

At step S216, when receiving the projection request from the mobile terminal 20, the projector 40 projects the file included in the received projection request. When the projection request includes projection settings, the projector 40 projects the file according to the projection settings.

As described above, the information storage system 1 of the present embodiment makes it possible to, for example, display and project a file stored in the information storage apparatus 10. Although an exemplary process of displaying a file on the mobile terminal 20 and projecting a file by the projector 40 is described above, the information storage system 1 of the present embodiment may also be applied to various other processes. For example, the process of FIG. 7 may be modified to print or display a file using the MFP 30 or an interactive whiteboard instead of the projector 40.

### Second Embodiment

In the information storage system 1 of the first embodiment, cache files are generated for a file (new file) when the file is newly stored in the file storage 213 of the information storage apparatus 10. In the information storage system 1 of a second embodiment, cache files are generated for a file (existing file) already stored in the file storage 213 of the information storage apparatus 10 when the file is edited and saved.

The system configuration, the hardware configuration, and the software configuration of the information storage system 1 of the second embodiment are substantially the same as those of the information storage system 1 of the first embodiment. Therefore, descriptions of those configurations are omitted here.

### <Process>

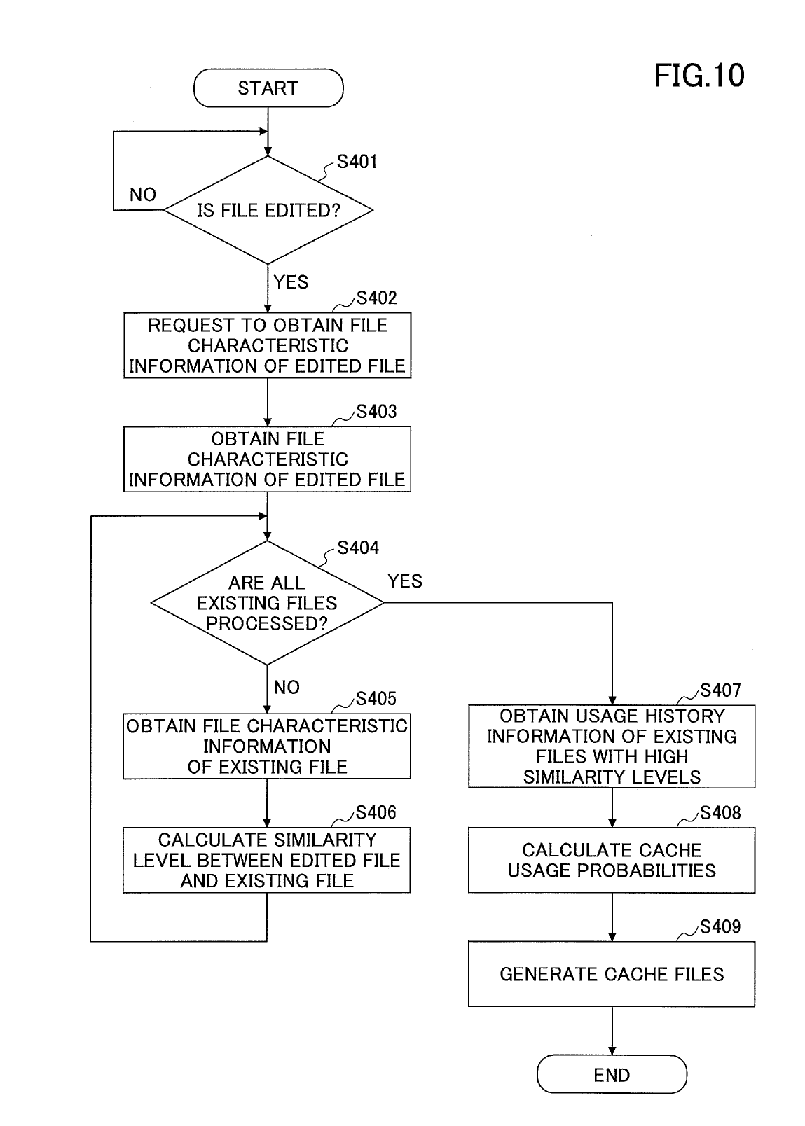

FIG. 10 is a flowchart illustrating an exemplary process performed by the information storage apparatus 10 of the second embodiment.

In this exemplary process, it is assumed that a user, by using the mobile terminal 20, obtains an original file from the file storage 213 of the information storage apparatus 10, edits the original file, and overwrites the original file in the file storage 213 with the edited file. Below, descriptions are simplified for steps in FIG. 10 that are similar to those in FIG. 5.

At step S401, when detecting that a file (which is hereafter referred to as an “original file”) stored in the file storage 213 is edited and saved (i.e., overwritten with the edited file), the file monitoring unit 204 proceeds to step S402.

At step S402, the usage probability calculation unit 205 requests the file characteristic management unit 206 to obtain file characteristic information of the edited file in the file storage 213.

At step S403, the file characteristic management unit 206 obtains the file characteristic information of the edited file in the file storage 213.

Then, the file characteristic management unit 206 and the usage probability calculation unit 205 repeat steps S405 and S406, respectively, until it is determined at step S404 that steps S405 and S406 are performed for all existing files. Here, the existing files indicate files other than the edited file (detected at step S401) that are stored in the file storage 213.

At step S405, the file characteristic management unit 206 obtains the file characteristic information of an existing file from the file characteristic storage 215.

At step S406, the usage probability calculation unit 205 calculates a similarity level between the edited file and the existing file based on the file characteristic information of the edited file obtained at step S403 and the file characteristic information of the existing file obtained at step S405.

After the similarity levels between the edited file and all the existing files are calculated, the process proceeds to step S407. At step S407, the usage history management unit 207 obtains, from the usage history storage 216, usage history information of existing files whose similarity levels are high.

At step S408, the usage probability calculation unit 205 calculates cache usage probabilities based on the usage history information obtained at step S407.

At step S409, the cache generation unit 209 generates one or more cache files of the edited file based of the cache usage probabilities calculated at step S408, and stores the generated cache files in the cache storage 214. The cache generation unit 209 is preferably configured to delete cache files previously generated for the original file of the edited file. This makes it possible to prevent shortage of storage space of the information storage apparatus 10.

As described above, the second embodiment makes it possible to generate cache files again for a file stored in the file storage 213 of the information storage apparatus 10 when the file is edited and saved. By generating cache files again for a file when the file is edited, it becomes possible to achieve a high cache hit ratio even when the usage (i.e., file characteristic information) of the file is changed by the editing.

### Third Embodiment

In the information storage system 1 of a third embodiment, cache files are generated again for a file stored in the file storage 213 of the information storage apparatus 10 when usage history information stored in the usage history storage 216 is changed.

The system configuration, the hardware configuration, and the software configuration of the information storage system 1 of the third embodiment are substantially the same as those of the information storage system 1 of the first embodiment. Therefore, descriptions of those configurations are omitted here.

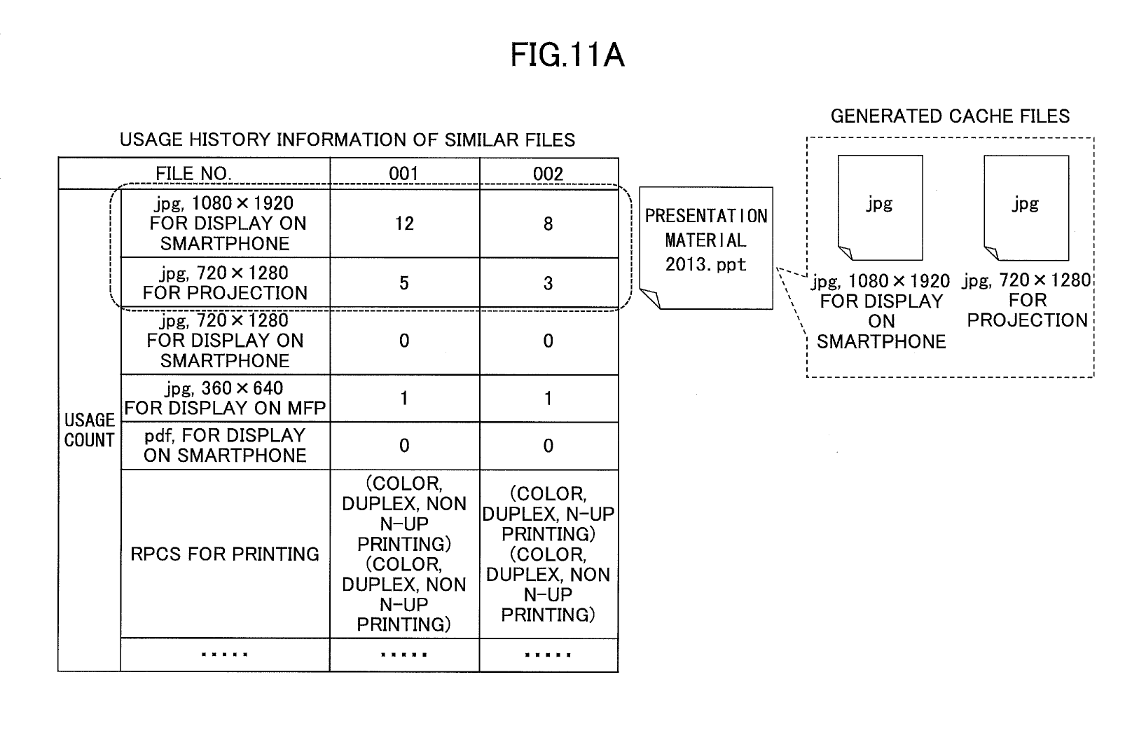

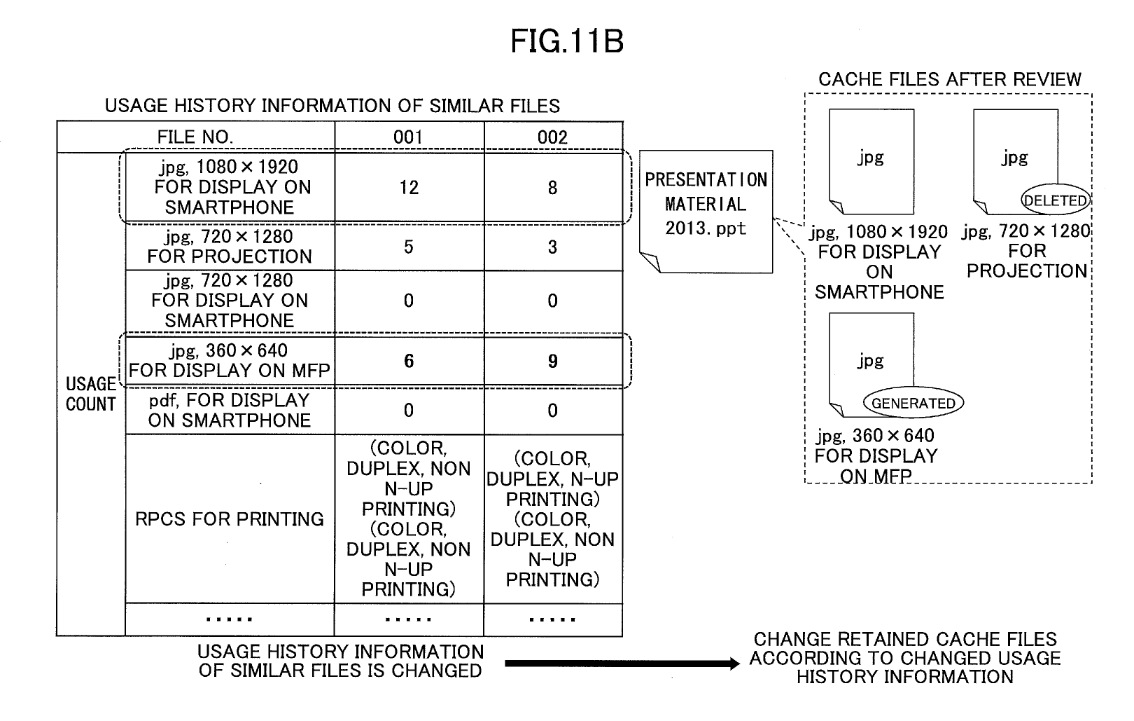

FIGS. 11A and 11B are drawings used to describe an exemplary process of revising the composition of cache files. FIG. 11A illustrates an exemplary case where cache files with data formats “jpg, 1080×1920 for display on smartphone” and “jpg, 720×1280 for projection” are generated for a new file “presentation material 2013.ppt” based on usage history information of the files No. 001 and No. 002 similar to the new file.

As illustrated by FIG. 11B, when the usage history information of the files No. 001 and No. 002 is changed after a certain period of time, cache files are generated again for the file “presentation material 2013.ppt” based on the changed usage history information. In the usage history information of FIG. 11B, the usage counts of the data format “jpg, 360×640 for display on MFP” of the files No. 001 and No. 002 have increased and become greater than the usage counts of the data format “jpg, 720×1280 for projection”. This indicates that the cache usage probability of the data format “jpg, 360×640 for display on MFP” has become higher than the data format “jpg, 720×1280 for projection”. Accordingly, a cache file with the data format “jpg, 360×640 for display on MFP” is newly generated and the cache file with the data format “jpg, 720×1280 for projection” is deleted to revise the composition of cache files.

Thus, the third embodiment makes it possible to generate cache files again for a file when usage history information of similar files changes (i.e., when there is a change in the trend of frequently-used data formats), and thereby makes it possible to prevent the decrease in the cache hit ratio. The composition of cache files may be revised, for example, every week.

### SUMMARY

As described above, the information storage system 1 of an embodiment of the present invention makes it possible to generate cache files expected to be frequently used based on file characteristic information of a file newly stored in the information storage apparatus 10 by the mobile terminal 20 or the PC 50, and thereby makes it possible to improve the cache hit ratio.

Also, when a file stored in the information storage apparatus 10 is edited and saved, the information storage system 1 of an embodiment of the present invention can generate cache files again based on file characteristic information of the edited file, and can thereby improve the cache hit ratio.

Further, when usage history information of files stored in the information storage apparatus 10 is changed, the information storage system 1 of an embodiment of the present invention can generate cache files again based on the changed usage history information, and can thereby improve the cache hit ratio.

The information storage apparatus 10 of an embodiment of the present invention can generate and retain cache files with data formats expected to be frequently used, and can thereby prevent shortage of storage space while preventing the decrease in the cache hit ratio.

The file storage 213 is an example of a first storage. The file monitoring unit 204 is an example of a detection unit. The usage probability calculation unit 205 is an example of a similarity calculation unit. The cache generation unit 209 is an example of a first conversion unit, a second conversion unit, and a deletion unit. The cache storage 214 is an example of a second storage. The usage history storage 216 is an example of a usage history storage. Each of Web API 201 and the SMB connection unit is an example of a reception unit and a transmission unit. The Web request execution unit 203 is an example of a first determination unit and a second determination unit.

An aspect of this disclosure provides an information processing apparatus, an information processing method, and a storage medium storing a program that can calculate similarity levels between a file and other files based on file characteristic information and convert a data format of the file based on the similarity levels.

An information processing apparatus, an information processing method, and a storage medium according to embodiments of the present invention are described above. However, the present invention is not limited to the specifically disclosed embodiments, and variations and modifications may be made without departing from the scope of the present invention.

What is claimed is:

1. An information processing apparatus connected via a network to an electronic apparatus, the information processing apparatus comprising:
a first storage that stores a first file received from the electronic apparatus in response to a request from the electronic apparatus;
a detection unit that detects that the first file is stored in the first storage;
a similarity calculation unit that calculates similarity levels between the first file and other files stored in the first storage based on characteristic information of the first file and characteristic information of the other files when the detection unit detects that the first file is stored in the first storage; and
a first conversion unit that generates a second file by converting a first data format of the first file into a second data format different from the first data format based on the similarity levels.

2. The information processing apparatus as claimed in claim 1, further comprising:
a second storage that stores the second file; and
a deletion unit that deletes the second file from the second storage when the second file is not requested by the electronic apparatus for a predetermined period of time.

3. The information processing apparatus as claimed in claim 2, further comprising:
a usage history storage that stores usage history information for each data format of each of the other files stored in the first storage, the usage history information of a data format of a file indicating a number of times that the file with the data format has been requested by the electronic apparatus,
wherein the first conversion unit generates the second file by converting the first data format of the first file into the second data format based on the similarity levels and the usage history information of the other files stored in the first storage.

4. The information processing apparatus as claimed in claim 3, wherein the first conversion unit generates the second file by converting the first data format of the first file into the second data format based on the usage history information of one or more of the other files whose similarity levels are high.

5. The information processing apparatus as claimed in claim 4, wherein the first conversion unit generates the second file by converting the first data format of the first file into the second data format that is determined to be frequently requested by the electronic apparatus based on the usage history information.

6. The information processing apparatus as claimed in claim 2, further comprising:
a reception unit that receives an acquisition request for requesting the first file from the electronic apparatus;
a first determination unit that determines whether the first data format of the requested first file is displayable by the electronic apparatus;
a second determination unit that determines whether the second data format of the second file stored in the second storage is displayable by the electronic apparatus when the first data format is not displayable by the electronic apparatus;
a second conversion unit that generates a third file by converting the first data format of the first file into a third data format displayable by the electronic apparatus when both of the first data format and the second data format are not displayable by the electronic apparatus; and
a transmission unit that transmits, to the electronic apparatus, one of the first file, the second file, and the third file which is displayable by the electronic apparatus.

7. A method performed by an information processing apparatus connected via a network to an electronic apparatus, the method comprising:
storing a first file received from the electronic apparatus in a storage in response to a request from the electronic apparatus;
detecting that the first file is stored in the storage;
calculating similarity levels between the first file and other files stored in the storage based on characteristic information of the first file and characteristic information of the other files when it is detected that the first file is stored in the first storage; and
generating a second file by converting a first data format of the first file into a second data format different from the first data format based on the similarity levels.

8. A non-transitory computer-readable storage medium having a program stored therein for causing an information processing apparatus connected via a network to an electronic apparatus to perform a method, the method comprising:
storing a first file received from the electronic apparatus in a storage in response to a request from the electronic apparatus;
detecting that the first file is stored in the storage;
calculating similarity levels between the first file and other files stored in the storage based on characteristic information of the first file and characteristic information of the other files when it is detected that the first file is stored in the first storage; and
generating a second file by converting a first data format of the first file into a second data format different from the first data format based on the similarity levels.
